(19) United States
(12) Patent Application Publication
(10) Pub. No.: US 2006/0137801 A1
(43) Pub. Date: Jun. 29, 2006

(54) Method of bonding ethylene-vinyl acetate copolymer formed product

(75) Inventors: Masaaki Matsushita, Tokyo (JP); Akiharu Takabayashi, Tokyo (JP); Ichiro Kataoka, Tokyo (JP); Hidehisa Makita, Tokyo (JP); Takaaki Mukai, Tokyo (JP); Shigenori Itoyama, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/544,371

(22) PCT Filed: Feb. 5, 2004
(86) PCT No.: PCT/JP04/01218

§ 371 Date: Aug. 3, 2005

(30) Foreign Application Priority Data
Feb. 6, 2003 (JP) 2003-029294
Jan. 23, 2004 (JP) 2004-015224

(51) Int. Cl. B32B 37/00

(52) U.S. Cl. 156/83; 156/307.3; 156/329

(57) ABSTRACT

A formed product having on at least part of its surface an ethylene-vinyl acetate copolymer (EVA) is bonded to an adherend by means of an adhesive containing at least xylene. According to the method of the present invention, the formed product having an ethylene-vinyl acetate copolymer with low adhesion to another substance can be easily bonded to the adherend.

### TECHNICAL FIELD

The present invention relates to a method of bonding a formed product having on at least part of its surface an ethylene-vinyl acetate copolymer, to an adherend.

### BACKGROUND ART

An ethylene-vinyl acetate copolymer (to be abbreviated as “EVA” hereinafter) has a carbonyl group in an ester bond in its molecular structure. However, this type of a polar group does not always have sufficient adhesive force to another substance, and it is therefore difficult to bond and fix an EVA formed product to an adherend by applying an adhesive to the surface of the formed product. To solve the problem, as methods for improving adhesion between the surface of an EVA formed product and another substance, flame treatment, corona discharge treatment, treatment with a mixture of chromic acid and sulfuric acid, etc. are used, all of which are surface treatment methods for a polyolefin or the like that provides activity to the surface of EVA.

However, the flame treatment and the corona discharge treatment have various problems in that the retention time of surface activity is short, with the result that an object having a complex shape cannot be uniformly treated, etc. Further, the treatment with a mixture of chromic acid and sulfuric acid may cause a problem in that the mixture that probably damages the surface of a formed product becomes harmful.

To improve the adhesion of EVA, there can be used to apply a coat of a resin having a polar group onto the surface of a formed product, and to blend EVA with a resin having a polar group in advance.

However, the method of coating the surface of a formed product with a resin having a polar group involves a problem in that when the formed product is coated with the resin in a solution state, the resin may separate out from the solution due to unsatisfactory adhesion between EVA and the coating resin because the EVA formed product is treated at a temperature equal to or lower than its softening temperature or deformation temperature. The method of blending EVA with a resin having a polar group in advance has disadvantages in that most of the resin is wasted because only the polar group present on the surface of the formed product acts effectively, and that a large amount of the resin having a polar group must be added because the blended resin even on the surface is covered with EVA, with the result that preferred intrinsic physical properties of EVA are impaired.

Alternatively, there are chemical methods for saponifying the surface of EVA in a solid state. The chemical methods include one in which powdery or particulate EVA is uniformly saponified at a high temperature in an alcohol such as methanol or ethanol in the presence of a small amount of a swelling agent and an alkali as a catalyst, and one in which EVA in a heterogeneous state is saponified in a mixture of methanol and propanol. Japanese Patent Application Laid-Open No. S60-57455 discloses a typical example of the above method and relates to a method of saponifying the surface of EVA by treatment with a mixture of a lower alcohol, an alkali and a solvent in order to facilitate second processing such as coating or printing.

Japanese Patent Application Laid-Open No. S60-57455 discloses the method of saponifying the surface of an EVA formed product. In the method, the surface of EVA having a vinyl acetate content of 2 to 35 wt % is treated with a mixture of a lower alcohol, an alkali and a solvent, thereby making it possible to saponify only the surface of the formed product at a low temperature in a short period of time very industrially advantageously without impairing the characteristics of EVA and to bond the EVA formed product to another substance easily. However, this method has problems in that a pretreatment step is required before EVA is bonded to another substance and work efficiency is low, resulting in increased cost, and that the physical properties of EVA might be impaired according to means in use.

The flame treatment, the corona discharge treatment and the treatment with a mixture of chromic acid and sulfuric acid also require a pretreatment step and have the same problems.

### DISCLOSURE OF THE INVENTION

It is an object of the present invention which has been made in view of the above circumstances to provide a bonding method capable of bonding a formed product having EVA with low adhesion to another substance on its surface to an adherend easily without impairing the intrinsic physical properties of EVA.

It is another object of the present invention to provide a bonding method capable of bonding the formed product easily at normal temperature to an adherend.

That is, the present invention relates to a method of bonding an ethylene-vinyl acetate copolymer formed product, characterized by including bonding a formed product having on at least part of its surface an ethylene-vinyl acetate copolymer to an adherend by means of an adhesive containing at least xylene.

Preferable embodiment modes of the bonding method according to the present invention include the following.

The formed product has a metal material.

The adhesive contains silicone.

The adhesive is of a dealcoholization type and a moisture curing type.

The adhesive is of a single-liquid curing type.

The adhesive has at least one of weatherability, heat resistance, cold resistance and water resistance.

The formed product is a solar cell.

The solar cell is an amorphous microcrystal silicon double-layer structure solar cell.

The adherend is an aluminum frame.

The adherend is a porous member.

The porous member is made of concrete.

The adhesive is applied for the bonding.

The bonding is carried out at normal temperature.

When the EVA surface of a formed product having EVA on at least part of its surface is bonded by an adhesive containing at least xylene, the EVA surface coated with the adhesive is swollen by xylene contained in the adhesive, and silicone or the like which is a component of the adhesive enters a gap between adjacent swollen EVA molecules, thereby making it possible to improve adhesion between EVA and the adhesive. The formed product can be easily bonded to an adherend even at normal temperature. The adhesive may contain silicone.

FIGS. 1A and 1B show EVA molecular models when an adhesive containing xylene and silicone is applied to a crosslinked EVA formed product according to the present invention. FIG. 1A shows the crosslinked EVA and FIG. 1B shows the surface of EVA after the adhesive is applied to the surface of EVA. Reference numeral 101 denotes a molecular model of the crosslinked EVA; 102, the surface of EVA coated with the adhesive; 103, an EVA molecule; 104, a gap between the swollen EVA molecules; and 105, a silicone molecule.

The EVA molecule 103 is swollen by xylene contained in the adhesive, and the silicone molecule 105 which is the main component of the adhesive enters the gap 104 between the swollen molecules.

Since the adhesive is a silicone adhesive, it can cope with a difference in thermal expansion coefficient among EVA, the adhesive and the adherend, whereby a creep and a fatigue failure hardly occur.

When the EVA formed product has a metal material, it is possible to prevent an alcohol from permeating through an organic polymer resin to erode the metal material of the EVA formed product because the adhesive is of a dealcoholization type. It is also possible to prevent the deterioration of the EVA formed product material and the deterioration of the adhesive itself.

Further, the adhesive is of a single-liquid and moisture curing type, so a heat source or the like is not used for curing. Therefore, unnecessary equipment is eliminated, thereby being capable of greatly improve the work efficiency.

Moreover, the adhesive has weatherability, heat resistance, cold resistance and/or water resistance, so the range of an environment where EVA is used can be expanded, and the durability and reliability of the adhesive after bonding can be improved.

Furthermore, since the adherend is a porous member, the adhesive enters the pores of the porous member and exhibits an anchoring effect, thereby making it possible to fix the EVA formed product more firmly.

### BRIEF DESCRIPTION OF THE DRAWINGS

FIGS. 1A and 1B are diagrams showing EVA molecular models when an adhesive containing xylene and silicone is applied to a crosslinked EVA formed product according to the present invention;

FIG. 2 is a schematic diagram of a structure obtained by bonding a formed product having EVA on its surface to an adherend by means of an adhesive containing xylene and silicone as a typical example of the present invention;

FIG. 3 is a schematic sectional view of a solar cell structure described in Example 1 of the present invention; and

FIGS. 4A, 4B, 4C, 4D, 4E and 4F are diagrams showing that an EVA formed product described in Example 2 of the present invention is bonded to an aluminum frame by means of an adhesive containing xylene.

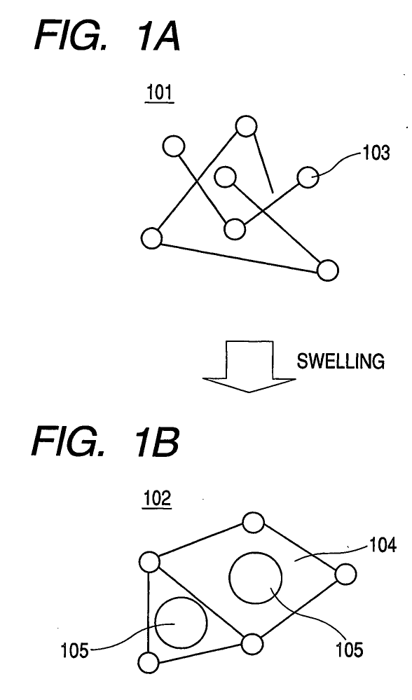

### BEST MODE FOR CARRYING OUT THE INVENTION

A method of bonding an EVA formed product according to an embodiment of the present invention will be described hereinbelow with reference to the accompanying drawings. The present invention is not limited to this embodiment.

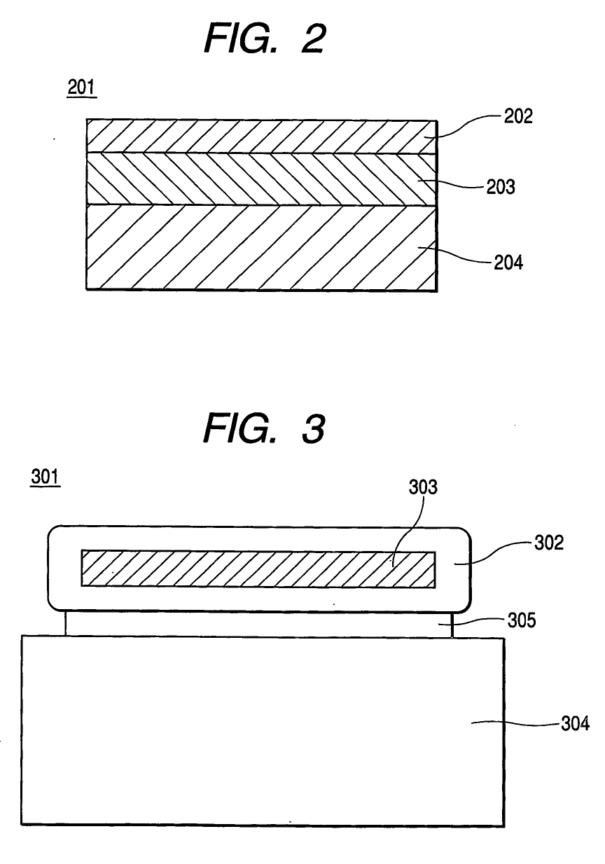

FIG. 2 is a schematic sectional view of a structure obtained by bonding a formed product having EVA on at least part of its surface to an adherend made of a metal-based material by means of an adhesive-containing xylene and silicone, which is of a dealcoholization type, a moisture curing type, and a single-liquid curing type. Reference numeral 201 denotes the structure obtained by bonding and fixing the EVA formed product; 202, the EVA formed product; 203, the adhesive; and 204, the adherend. Ethylene-vinyl acetate copolymer (EVA) formed product

The ethylene-vinyl acetate copolymer (EVA) is a transparent organic polymer resin and used to protect an object from a severe external environment such as temperature variations, humidity and impact. Since EVA has a low thermal deformation temperature as it is, EVA easily deforms or creeps when used at a high temperature. Therefore, it is desirable that the heat resistance of EVA should be improved by crosslinking. EVA is generally crosslinked with an organic peroxide. Crosslinking with an organic peroxide is carried out by allowing a free radical formed from the organic peroxide to extract a hydrogen or halogen atom contained in the resin to form a C—C bond. As methods of activating the organic peroxide, there are known thermal decomposition, redox decomposition and ion decomposition. In general, thermal decomposition is preferably carried out. Specific examples of the chemical structure of the organic peroxide include hydroperoxides, dialkyl(allyl)peroxides, diacyl peroxides, peroxyketals, peroxyesters, peroxycarbonates and ketone peroxides.

Examples of the hydroperoxides include t-butyl peroxide, 1,1,3,3-tetramethylbutyl peroxide, p-menthane hydroperoxide, cumene hydroperoxide, p-cymene hydroperoxide, diisopropylbenzene peroxide, 2,5-dimethylhexane-2,5-dihydroperoxide, cyclohexane peroxide, and 3,3,5-trimethylhexanone peroxide.

Examples of dialkyl(allyl)peroxides include di-t-butyl peroxide, dicumyl peroxide, and t-butyl cumyl peroxide.

Examples of the diacyl peroxides include diacetyl peroxide, dipropionyl peroxide, diisobutyryl peroxide, dioctanoyl peroxide, didecanoyl peroxide, dilauroyl peroxide, bis(3,3,5-trimethylhexanoyl)peroxide, benzoyl peroxide, m-toluyl peroxide, p-chlorobenzoyl peroxide, 2,4-dichlorobenzoyl peroxide, and peroxysuccinic acid.

Examples of the peroxyketals include 2,2-di-t-butylperoxybutane, 1,1-di-t-butylperoxycyclohexane, 1,1-di-(t-butylperoxy)-3,3,5-trimethylcyclohexane, 2,5-dimethyl-2,5-di(t-butylperoxy)hexane, 2,5-dimethyl-2,5-di(t-butylperoxy)hexyne-3,1,3-di(t-butylperoxyisopropyl)benzene, 2,5-dimethyl-2,5-dibenzoylperoxyhexane, 2,5-dimethyl-2,5-di(peroxybenzoyl)hexyne-3, n-butyl-4,4-bis(t-butylperoxy)valerate

Examples of the peroxyesters include t-butyl peroxyacetate, t-butyl peroxyisobutyrate, t-butyl, peroxypivalate, t-butyl peroxyneodecanoate, t-butyl peroxy-3,5,5-trimethylhexanoate, t-butyl peroxy-2-ethylhexanoate, (1,1,3,3-tetramethylbutylperoxy)-2-ethylhexanoate, t-butyl peroxylaurate, t-butyl peroxybenzoate, di(t-butylperoxy)adipate, 2,5-dimethyl-2,5-di(peroxy-2-ethylhexanoyl)hexane, di(t-butylperoxy)isophthalate, t-butyl peroxymalate, and acetylcyclohexylsulfonyl peroxide.

Examples of the peroxycarbonates include t-butyl peroxyisopropylcarbonate, di-n-propyl peroxydicarbonate, di-sec-butyl peroxydicarbonate, di(isopropylperoxy)dicarbonate, di(2-ethylhexylperoxy)dicarbonate, di(2-ethoxyethylperoxy)dicarbonate, di(methoxidepropylperoxy)carbonate, di(3-methoxybutylperoxy)dicarbonate, and bis-(4-t-butylcyclohexylperoxy)dicarbonate.

Examples of the ketone peroxides include acetyl acetone peroxide, methyl ethyl ketone peroxide, methyl isobutyl ketone peroxide, and ketone peroxide. As another structures, vinyltris(t-butylperoxy)silane and the like are known.

The addition amount of the organic peroxide is 0.5 to 5 parts by weight based on 100 parts by weight of the filler resin.

Crosslinking and thermocompression boding can be carried out under pressure and heating by adding the above organic peroxide to the filler. The heating temperature and time may be determined according to the thermal decomposition temperature characteristics of each organic peroxide. In general, heating and pressurization are ended at a temperature and time with which thermal decomposition proceeds 90% or more, preferably 95% or more. The gel fraction of the filler is preferably 80% or more. The gel fraction is obtained from the following equation.
Gel fraction=(weight of undissolved product/original weight of sample)×100 (%)

That is, when the transparent organic polymer resin is extracted with a solvent such as xylene, a portion gelated by crosslinking does not elute but only an uncrosslinked solated portion elutes. A gel fraction of 100% means that crosslinking is perfectly completed. Only the undissolved gel portion can be obtained by taking out the residual sample after extraction and evaporating xylene.

When the gel fraction is lower than 80%, the obtained product is inferior in heat resistance and creep resistance. Therefore, a problem occurs when the product is used at a high temperature in summer or the like.

To carry out the crosslinking reaction efficiently, a triallyl isocyanurate (TAIC) called “crosslinking aid” is desirably used. The addition amount of TAIC is generally 1 to 5 parts by weight based on 100 parts by weight of the filler resin. In this case, the vinyl acetate content in EVA is desirably 20 to 30%. When EVA has a vinyl acetate content of 20% or less and the same degree of crosslinking, EVA becomes an extremely hard filler and inferior in flexible processability because its crosslinking density becomes high. When EVA has a vinyl acetate content of 30% or more, EVA becomes too soft and easily wrinkles at a concave portion.

The material of the filler used in the present invention is excellent in weatherability. To further improve its weatherability or protect a filler lower layer, an ultraviolet light absorber may also be used. Compounds known as an ultraviolet light absorber may be used but an ultraviolet light absorber having low volatility is preferably used in consideration of the use environment of the formed product. When an optical stabilizer is used in combination with an ultraviolet light absorber, a more stable filler to light is obtained. Specific examples of the chemical structure of the optical stabilizer include salicylate-based, benzophenone-based, benzotriazole-based or cyanoacrylate-based compounds.

Examples of the salicylate-based compounds include phenyl salicylate, p-tert-butylphenyl salicylate, and p-octylphenyl salicylate.

Examples of the benzophenone-based compounds include 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4-methoxybenzophenone, 2,2′-dihydroxy-4,4′-dimethoxybenzophenone, and 2-hydroxy-4-methoxy-5-sulfobenzophenone, and bis(2-methoxy-4-hydroxy-5-benzophenone)methane.

Examples of the benzotriazole includes, 2-(2′-hydroxy-5′-methylphenyl)benzotriazole, 2-(2′-hydroxy-5′-tert-butylphenyl)benzotriazole, 2-(2′-hydroxy-3′,5′-di-tert-butylphenyl)benzotriazole, 2-(2′-hydroxy-3′-tert-butyl-5-methylphenyl)-5-chlorobenzotriazole, 2-(2′-hydroxy-3′,5′-di-tert-butylphenyl)-5-chlorobenzotriazole, 2-(2′-hydroxy-3′,5′-di-tert-amylphenyl)benzotriazole, 2-{2′-hydroxy-3′-(3″,4″,5″,6″-tetrahydrophthalimidomethyl)-5′-methylphenyl}benzotriazole, and 2,2-methylenebis{4-(1,1,3,3-tetramethylbutyl)-6-(2H-benzotriazole-2-yl)phenol}.

Examples of the cyanoacrylate-based compounds include 2-ethylhexyl-2-cyano-3,3′-diphenyl acrylate and ethyl-2-cyano-3,3′-diphenyl acrylate.

At least one of the above ultraviolet light absorbers is preferably added to the filler used in the present invention. Other than using the ultraviolet light absorber, it is known that a hindered amine-based optical stabilizer may be used as means of providing weatherability. Although the hindered amine-based optical stabilizer does not absorb ultraviolet light unlike the ultraviolet light absorber, when the hindered amine-based optical stabilizer is used in combination with an ultraviolet light absorber, a marked synergic effect can be obtained. The addition amount of the optical stabilizer is generally about 0.1 to 0.3 parts by weight based on 100 parts by weight of the resin. As a matter of course, there are compounds which serve as an optical stabilizer other than the hindered amine-based optical stabilizers. Most of them are colored and are therefore not desirable to be added to the filler of the present invention.

Known examples of the hindered amine-based optical stabilizers include a dimethyl succinate-1-(2-hydroxyethyl)-4-hydroxy-2,2,6,6-tetramethylpiperidine polycondensate, poly[{6-(1,1,3,3-tetramethylbutyl)amino-1,3,5-triazin-2,4,-diyl}{{2,2,6,6-tetramethyl-4-piperidyl)imino}hexamethylene{(2,2,6,6-tetramethyl-4-piperidyl)imino}], N,N′-bis(3-aminopropyl)ethylenediamine-2,4-bis[N-butyl-N-(1,2,2,6,6-pentamethyl-4-piperidyl)amino]-6-chloro-1,3,5-triazine condensate, bis(2,2,6,6-tetramethyl-4-piperidyl)sebacate, and 2-(3,5-di-tert-4-hydroxybenzyl)-2-n-butyl malonate bis(1,2,2,6,6-pentamethyl-4-piperidyl).

Further, an antioxidant may be added to improve heat resistance/thermal processability. The addition amount of the antioxidant is suitably 0.1 to 1 parts by weight based on 100 parts by weight of the resin. The chemical structure of the antioxidant is roughly classified into monophenol-based, bisphenol-based, polymeric phenol-based, sulfuric-based, and phosphite-based antioxidants. Examples of the monophenol-based antioxidants include 2,6-di-tert-butyl-p-cresol, butylated hydroxyanisole and 2,6-di-tert-butyl-4-ethylphenol.

Examples of the bisphenol-based antioxidants include 2,2′-methylene-bis-(4-methyl-6-tert-butylphenol), 2,2′-methylene-bis-(4-ethyl-6-tert-butylphenol), 4,4′-thiobis-(3-methyl-6-tert-butylphenol), 4,4′-butylidene-bis-(3-methyl-6-tert-butylphenol), and 3,9-bis{1,1-dimethyl-2-{β-(3-tert-butyl-4-hydroxy-5-methylphenyl)propionyloxy}ethyl}2,4,8,10-tetraoxaspiro}5,5-undecane.

Examples of the polymeric phenol-based antioxidants include 1,1,3-tris-(2-methyl-4-hydroxy-5-tert-butylphenyl)butane, 1,3,5-trimethyl-2,4,6-tris(3,5-di-tert-butyl-4-hydroxybenzyl)benzene, tetrakis-{methylene-3-(3′,5′-di-tert-butyl-4′-hydroxyphenyl)propionate}methane, bis(3,3′-bis-4′-hydroxy-3′-tert-butylphenyl)butylic acid}glycol ester, 1,3,5-tris(3′,5′-di-tert-butyl-4′-hydroxybenzyl)-s-triazin-2,4,6-(1H,3H,5H)trione, and tocopherol (vitamin E).

On the other hand, examples of the sulfur-based antioxidants include, dilauryl thiodipropionate, dimyristyl thiodipropionate, and distearyl thiopropionate.

Examples of the phosphite-based antioxidants include triphenyl phosphite, diphenylisodecyl phosphite, phenyldiisodecyl phosphite, 4,4′-butylidene-bis-(3-methyl-6-tert-butylphenyl-di-tridecyl)phosphite, cyclic neopentanetetraylbis(octadecylphosphite), tris(mono and/or diphenyl)phosphite, diisodecyl pentaerythritol diphosphite, 9,10-dihydro-9-oxa-10-phosphaphenanthrene-10-oxide, 10-(3,5-di-tert-butyl-4-hydroxybenzyl)-9,10-dihydro-9-oxa-10-phosphaphenanthrene-10-oxide, 10-decyloxy-9,10-dihydro-9-oxa-10-phosphaphenanthrene, cyclic neopentanetetraylbis(2,4-di-tert-butylphenyl)phosphite, cyclic neopentanetetraylbis(2,6-di-tert-methylphenyl)phosphite, and 2,2-methylenebis(4,6-tert-butylphenyl)octyl phosphite.

When the formed product is to be used in a more severe environment, it is preferred to improve its adhesion to the adherend.

It is possible to improve the adhesion by adding a silane coupling agent or an organic titanate compound to the filler. The addition amount of the silane coupling agent or the organic titanate compound is preferably 0.1 to 3 parts by weight, more preferably 0.25 to 1 part by weight based on 100 parts by weight of the filler resin. Further, in order to improve adhesion between the impregnated fibrous inorganic compound and the transparent organic polymer compound, it is effective to add a silane coupling agent or an organic titanate compound to the transparent organic polymer. Specific examples of the silane coupling agents include vinyltrichlorosilane, vinyltris(β-methoxyethoxy)silane, vinyltriethoxysilane, vinyltrimethoxysilane, γ-methacryloxypropyltrimethoxysilane, β-(3,4-epoxycyclohexyl)ethyltrimethoxysilane, γ-glycidoxypropylmethyldiethoxysilane, N-β(aminoethyl)γ-aminopropyltrimethoxysilane, N-β(aminoethyl)γ-aminopropylmethyldimethoxysilane, γ-aminopropyltriethoxysilane, N-phenyl-γ-aminopropyltrimethoxysilane, γ-mercaptopropyltrimethoxysilane, and γ-chloropropyltrimethoxysilane.

When the filler is used for a formed product, which requires light transmission, the filler must be transparent in order to suppress a reduction in the amount of light. When the formed product is a solar cell, the light transmittance of the filler is preferably 80% or more, more preferably 90% or more at a visible light wavelength range of 400 nm to 800 nm. To facilitate the input of light from the atmosphere, the refractive index of the filler is preferably 1.1 to 2.0, more preferably 1.1 to 1.6 at 25° C.

Adhesive

The adhesive in the present invention is a silicone adhesive containing xylene. The xylene content in the adhesive is preferably 10 to 50 wt %, more preferably 20 to 30 wt %.

The silicone adhesive is often used as a sealing material. Typical examples of the silicone adhesive include (i) single-liquid type silicone adhesives, (ii) low-modulus two-component type adhesives, (iii) ceramic adhesives, (iv) acid resistant adhesives, (v) elastic adhesives and (vi) adhesives for SSG.

The single-liquid type silicone adhesives (I) include (a) single-liquid type high-modulus adhesives, (b) single-liquid type low-modulus silicone adhesives, and (c) single-liquid type silicone adhesives for plastics.

The single-liquid type high-modulus adhesives (a) are oxime type silicone adhesives and the most general-purpose adhesives. The adhesives are used for butt joints in the glass screening method for commercial buildings, joints of glass (between glass and a metal frame), joints in the interior of a housing (such as a lavatory, washroom and showcase), joints in a bathtub, and expansion joints in the external wall of a prefabricated house for the purpose of waterproofing a house. Silicone adhesives packaged in a tube are used to repair a bathroom, kitchen, washroom, lavatory and external wall. There are also transparent and mildew resistant adhesives.

The single-liquid type low-modulus silicone adhesives (b) are suitable for greatly expandable joints. However, the adhesives have such a drawback that they have lower adhesive force than the high-modulus adhesives.

The single-liquid type silicone adhesives for plastics (c) are alcohol type sealants developed specifically for plastics and satisfactorily bonds an acrylic resin which is said to be hardly bonded. The adhesives are free from corrosive properties (stress cracking etc.) with respect to plastics.

As for the low-modulus two-component adhesives (ii), to reduce the modulus of the adhesives, a plasticizer is added, or the number of crosslinking points is reduced in general. A silicone low-modulus adhesive includes a trifunctional curing agent and a bifunctional curing agent to achieve its low modulus. This is a technique for causing a chain length extension reaction for reducing the modulus simultaneously with a crosslinking reaction and is not used for adhesives other than silicone adhesives. Since the curing system is of an aminoxy type and a hydroxylamine which is a condensate serves as a catalyst, a reaction can be carried out without adding a catalyst. To obtain an elastic adhesive, the adhesive must have a 150% modulus when it is an H type sample based on JISA5758 of 19.6 N/cm² (2 kgf/cm²) or more. When the 150% modulus is lower than that, the adhesive shows plastic behavior and has problems with its resistance to fatigue and bonding durability.

The ceramic adhesives (iii) are sealants having a low modulus and high elongation and provided with fire resistance and flame retardancy in addition to the excellent durability, heat resistance and weatherability of a silicone sealant. When the adhesives are burnt, they become a ceramic, do not peel off from a joint etc, and prevent the entry of flame and smoke.

The elastic adhesives (v) include condensate oxime solvent type adhesives, emulsions and top coat materials.

The SSG adhesives (vi) are excellent in adhesion durability for high-performance heat ray reflection glass and metal mullion and also excellent in weatherability, heat resistance and cold resistance.

The adhesive in the present invention can be obtained by adding xylene to the silicone adhesive. Xylene is extracted mainly from the contact modified fat of petroleum naphtha and thermally cracked oil residue, separated from paraffin-based oil together with benzene and toluene by using a solvent such as diethylene glycol, methyl sulfolane, N-methylpyrrolidone, dimethyl sulfoxide or N-formylmorpholine, and obtained as a fraction having eight carbon atoms by precision distillation. The ratio of benzene, toluene and xylene of each stock oil is about 1:3:4 in the case of contact modified oil, about 10:8:5 in the case of the cracked oil residue, and about 7:2:1 in the case of petroleum tar light oil. To obtain xylene, contact modified oil which is rather heavy aromatic in composition is advantageous.

The separated fraction having eight carbon atoms contains not only ortho-, meta- and para-isomers of xylene but also ethylbenzene. This fraction is often used in a solvent as xylene as it is and is called “mixed xylene” to distinguish it from pure isomers.

The adhesive in the present invention is preferably the single-liquid dealcoholization type elastic silicone adhesive that contains xylene.

Adherend

The adherend in the present invention is a member for mounting or reinforcing a formed product having EVA (such as a solar cell), and its material is not particularly limited. For example, the material is a metal steel plate such as a coated zinc steel plate or a stainless steel plate, which can be bent and has excellent weatherability and rust resistance. However, a concrete member which has weatherability and can greatly reduce material cost is preferred, and a concrete board which is a plate-like member and a concrete block are particularly preferred.

The present invention will be described in detail with reference to examples, but the present invention is not limited thereto.

### EXAMPLE 1

In this example, an amorphous microcrystal silicon double-layer structure solar cell coated with EVA is bonded and fixed to a concrete block made of a porous member by means of a silicone adhesive containing xylene (SE737 of TORAY DOW CORNING SILICONE).

FIG. 3 is a sectional view of a solar cell structure 301 manufactured by bonding an amorphous microcrystal silicon double-layer structure solar cell 303 having EVA 302 on its rear surface described in this example to a porous concrete block 304 by means of the above adhesive 305 containing xylene. As for its manufacturing procedure, an unrequited material on the surface of EVA which is a bonding surface and on the concrete block 304 is removed, and the adhesive (SE737 of TORAY DOW CORNING SILICONE) is applied to the surface of EVA 302 to bond the solar cell to the concrete block 304.

### EXAMPLE 2

In this example, an EVA formed product including glass, a solar cell, a weathering resistant white rear-surface film and EVA as an adhesive is bonded to an aluminum frame which is a reinforcing member for the EVA formed product by means of a silicone adhesive containing xylene.

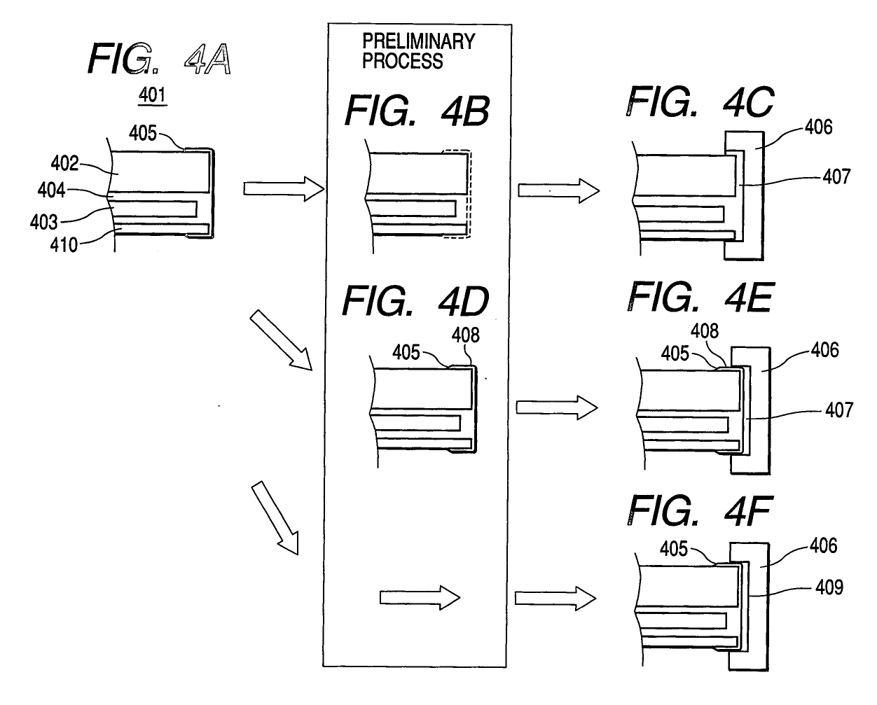

FIGS. 4A to 4F are schematic diagrams showing that an EVA formed product manufactured by using EVA as an adhesive described in this example to bond the solar cell to a glass substrate is bonded to the aluminum frame which is a reinforcing material for the EVA formed product.

FIG. 4A is a diagram showing the constitution of a solar cell module 401 manufactured by using a glass substrate 402, a solar cell 403, a weathering resistant white rear-surface film 410 and EVA 404.

Since the glass substrate 402 and the solar cell 403 are bonded together at a high temperature to manufacture the solar cell module 401, EVA 404 softens and flows out from the end portion of the module, resulting in a state 405 in which EVA adheres to the side of the end portion in most cases. Therefore, when butyral or the like which is a conventionally known adhesive is used to fix the solar cell module 401 to the aluminum frame 406 so as to mount the reinforcing aluminum frame 406, the module and the frame cannot be fixed to each other firmly because adhesion between EVA and the adhesive is low.

To cope with this, in the prior art, as shown in FIG. 4B, EVA 405 adhered to the end portion of the solar cell module 401 is removed, and an ordinary solvent-free silicone adhesive 407 containing no xylene is used to bond the solar cell module 401 to the aluminum frame 406 as shown in FIG. 4C. Thus, the solar cell module 401 can be firmly fixed to the aluminum frame 406. However, a preliminary step for removing the adhered EVA 405 is required, thereby boosting cost and reducing work efficiency. Further, the solar cell module 401 might be damaged when the adhered EVA 405 is removed.

When a primer 408 is applied to the surface of EVA 405 adhered to the end portion of the solar cell module 401 as shown in FIG. 4D, the solar cell module 401 can be bonded and fixed to the aluminum frame 406 as shown in FIG. 4E and it is possible to prevent the damage of the solar cell module 401. However, a pretreatment step for applying the primer 408 is required before the solar cell module 401 is bonded and fixed to the aluminum frame 405 like the above method, thereby increasing the number of manufacturing steps and boosting material cost.

Then, in the present invention, the silicone adhesive containing xylene (SE737 of TORAY DOW CORNING SILICONE) 409 is used. Thus, an agglomerate of EVA molecules on the surface of the crosslinked EVA 405 is swollen by xylene, and silicone or the like which is a component of the adhesive enters the gap between adjacent swollen EVA molecules to improve adhesion. As a result, the solar cell module 401 can be firmly fixed to the aluminum frame 406 without damaging the solar cell module 401 and without requiring preliminary steps as shown in FIG. 4B and FIG. 4D, thereby making it possible to greatly improve work efficiency and reduce cost.

### INDUSTRIAL APPLICABILITY

According to the method of bonding an ethylene-vinyl acetate copolymer (EVA) formed product of the present invention, the formed product having an ethylene-vinyl acetate copolymer (EVA) with low adhesive force to another substance can be easily bonded to the adherend, and it is possible to greatly improve the work efficiency and reduce cost. The formed product can be bonded even at normal temperature.

1. A method of bonding an ethylene-vinyl acetate copolymer formed product, comprising bonding a formed product having on at least part of its surface an ethylene-vinyl acetate copolymer to an adherend by means of an adhesive containing at least xylene.

2. A method according to claim 1, wherein the adhesive contains silicone.

3. A method according to claim 1, wherein the adhesive is of a dealcoholization type and a moisture curing type.

4. A method according to claim 1, wherein the adhesive is of a single-liquid curing type.

5. A method according to claim 1, wherein the adhesive has at least one of weatherability, heat resistance, cold resistance and water resistance.

6. A method according to claim 1, wherein the formed product has a metal material.

7. A method according to claim 1, wherein the formed product is a solar cell.

8. A method according to claim 7, wherein the solar cell is an amorphous microcrystal silicon double-layer structure solar cell.

9. A method according to claim 1, wherein the adherend is an aluminum frame.

10. A method according to claim 1, wherein the adherend is a porous member.

11. A method according to claim 10, wherein the porous member is made of concrete.

12. A method according to claim 1, wherein the adhesive is applied for the bonding.

13. A method according to claim 1, wherein the bonding is carried out at normal temperature.
